(19) United States
(12) Patent Application Publication
(10) Pub. No.: US 2016/0085427 A1
(43) Pub. Date: Mar. 24, 2016

(54) SYSTEM AND METHOD OF SHARING SPATIAL DATA

(71) Applicant: Caterpillar Inc., Peoria, IL (US)

(72) Inventors: Brett A. Eisenmenger, Everton Hills (AU); Joseph S. Glynn, Varisty Lakes (AU); Martin Pienaar, Wynnum West (AU)

(73) Assignee: CATERPILLAR INC., Peoria, IL (US)

(21) Appl. No.: 14/491,347

(22) Filed: Sep. 19, 2014

(51) Int. Cl. G06F 3/0484

(52) U.S. Cl. CPC G06F 3/04847; G06F 3/04842

(57) ABSTRACT

A method for sharing spatial data between a first geographic information system and a second geographic information system is provided. The method includes receiving a description of a first set of layers of spatial data, available on the first geographic information system, by the second geographic information system. The method includes defining a user interface on the second geographic information system. The method includes selecting layers through the user interface based on a user input. The selected layers includes at least a subset of at least one of the first set of layers of spatial data or the second set of layers of spatial data. The method includes receiving the subset of the first set of layers of spatial data from the first geographic information system, based on the selection. The method includes displaying an overlay of the selected layers on the second geographic information system.

### TECHNICAL FIELD

The present disclosure relates to a system and method of sharing spatial data, and more specifically to the system and method of sharing spatial data between a first geographic information system and a second geographic information system.

### BACKGROUND

Different geographical information systems may specialize in management of different aspects of spatial data. Sometimes it may be required to visualize certain aspects of the spatial data available on one system on that of another. External data may be overlaid on internal data available on the geographical information system. However, in such situations, the capabilities of an external data source may be static, unlike the capabilities and environment provided by the geographical information systems, which may change on a real-time basis.

United States Published Application Number 2008/0278311 describes a geographical information system (GIS) for integrating multiple spatial emergency data, multiple non-spatial emergency data or both multiple spatial emergency data and multiple non-spatial emergency data into a real-time GIS for analyzing emergency data. A method for integrating multiple spatial emergency data, multiple non-spatial emergency data or both multiple spatial emergency data and multiple non-spatial emergency data into a real-time GIS for analyzing emergency data are also described.

### SUMMARY OF THE DISCLOSURE

In one aspect of the present disclosure, a method for sharing spatial data between a first geographic information system and a second geographic information system is provided. The method includes receiving a description of a first set of layers of spatial data, available on the first geographic information system, by the second geographic information system. The method includes defining a user interface on the second geographic information system. The user interface is configured to include a second set of layers of spatial data available on the second geographic information system and the first set of layers of spatial data based, at least in part, on the received description. The method includes selecting layers through the user interface based on a user input. The selected layers includes at least a subset of at least one of the first set of layers of spatial data or the second set of layers of spatial data. The method includes receiving the subset of the first set of layers of spatial data from the first geographic information system, based on the selection. The method includes displaying an overlay of the selected layers on the second geographic information system based, at least in part, on the selection.

In another aspect of the present disclosure, a computer based system is provided. The system includes a first geographic information system including a plurality of geographical information servers and human machine interface devices respectively. The first geographic information system is configured to store a first set of layers of spatial data associated with a number of machines operating on a worksite. The system includes a second geographic information system including a plurality of other geographical information servers and human machine interface device respectively. The second geographic information system is configured to store a second set of layers of the spatial data associated with the number of machines operating on the worksite. The second set of layers is different from the first set of layers. The second geographic information system further includes a receiving module, a user interface module, a selection module, and a display module. The receiving module is configured to receive a description of the first set of layers of spatial data from the first geographic information system. The user interface module is configured to define a user interface including the second set of layers of spatial data and the first set of layers based, at least in part, on the received description. The selection module is configured to select layers through the user interface based on a user input. The selected layers includes at least a subset of at least one of the first set of layers of spatial data or the second set of layers of spatial data. The display module is configured to receive the subset of the first set of layers of spatial data from the first geographic information system, based on the selection. The display module is configured to display an overlay of the selected layers on the second geographic information system based, at least in part, on the selection.

In yet another aspect of the present disclosure, a non-transitory computer-readable medium is provided. The non-transitory computer-readable medium has stored thereon sequences of instruction. The sequences of instruction including instruction which when executed by a computer based system for sharing spatial data between a first geographic information system and a second geographic information system, causes the second geographic information system to perform operations, including receiving a description of a first set of layers of spatial data, available on the first geographic information system, by the second geographic information system. Further, to perform operations including defining a user interface on the second geographic information system. The user interface is configured to include a second set of layers of spatial data available on the second geographic information system and the first set of layers of spatial data based, at least in part, on the received description. Further, to perform operations including selecting layers through the user interface based on a user input. The selected layers includes at least a subset of at least one of the first set of layers of spatial data or the second set of layers of spatial data. Further, to perform operations including receiving the subset of the first set of layers of spatial data from the first geographic information system, based on the selection. Further, to perform operations including displaying an overlay of the selected layers on the second geographic information system based, at least in part, on the selection.

Other features and aspects of this disclosure will be apparent from the following description and the accompanying drawings.

### BRIEF DESCRIPTION OF THE DRAWINGS

FIG. 1 is a block diagram of an exemplary spatial data information sharing system including a first geographic information system and a second geographic information system, according to one embodiment of the present disclosure;

FIG. 2 is a block diagram of the second geographic information system of FIG. 1, according to one embodiment of the present disclosure;

FIG. 3 is an exemplary visual display viewable on the first geographic information system, according to one embodiment of the present disclosure;

FIGS. 4 are 5 are exemplary visual displays viewable on the second geographic information system, according to one embodiment of the present disclosure;

FIG. 6 is a block diagram of an exemplary computer based system, according to an embodiment of the present disclosure; and

FIG. 7 is a flowchart of a method for sharing the spatial data between the first geographic information system and the second geographic information system.

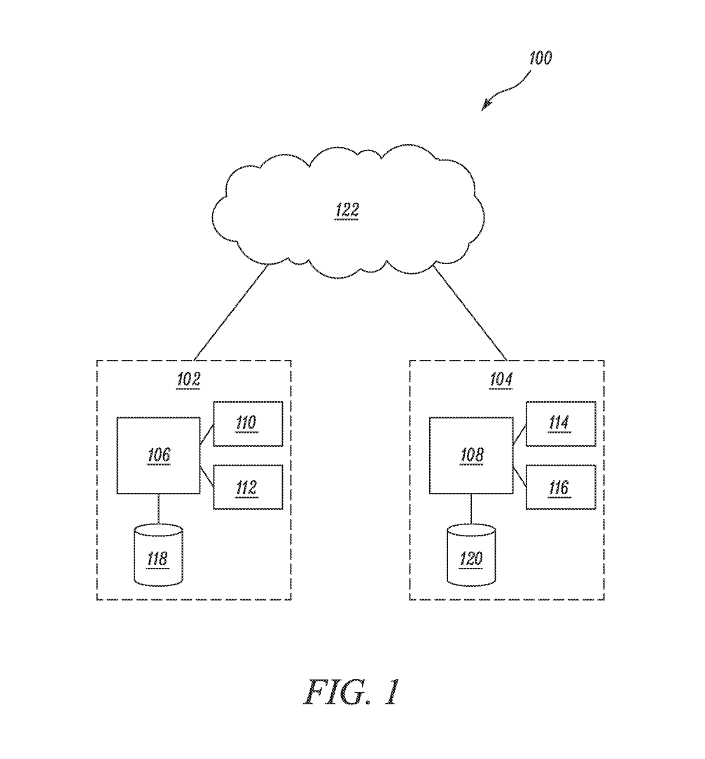

### DETAILED DESCRIPTION

Wherever possible, the same reference numbers will be used throughout the drawings to refer to the same or the like parts. FIG. 1 is a block diagram of an exemplary spatial data information sharing system 100, according to one embodiment of the present disclosure. The spatial data information sharing system 100 includes a first geographic information system 102 and a second geographic information system 104. Each of the first and second geographic information systems 102, 104 may include a number of geographical information servers 106, 108 for storage of the spatial data therein. Also, each of the first and second geographic information systems 102, 104 may include a number of human machine interface devices 110, 112, 114, 116 for interacting with the respective geographical information servers 106, 108 to retrieve the spatial data stored therein.

The geographical information servers 106, 108 of the first and second geographic information systems 102, 104 are used for creating, storing, analyzing and managing the spatial data and associated attributes, and displaying geographically referenced information. There are several methods for displaying two-dimensional and three-dimensional characteristics of the Earth's surface and atmosphere from information stored in the geographical information servers 106, 108. Among the methods to store information in the geographical information servers 106, 108 are topological modeling, networks, cartographic modeling and map overlay.

The spatial data stored on associated databases 118, 120 of the geographical information servers 106, 108 represent real world objects, such as, roads, land use and elevation, with digital data. For example, the spatial data information sharing system 100 may be employed on a worksite having a number of different machines deployed thereon. In this case, the real world objects to which the spatial data corresponds may be divided into two abstractions: discrete objects, such as, for example, a tower on the worksite, walled boundaries of the worksite, and so on; and continuous fields, such as, for example, elevation of terrain of the worksite, roads or lanes, work zones, and so on. Accordingly, in one example, the first geographic information system 102 may include a terrain data management system configured to store a first set of layers of spatial data associated with the terrain of the worksite, and the second geographic information system 104 may include a fleet management system configured to store a second set of layers of spatial data associated with the machines operating on the worksite. A person of ordinary skill in the art will appreciate that the first and second set of layers of the spatial data may be distinct or different from each other, based on the aspect of the spatial data being represented.

There are a variety of methods for entering the spatial data into the geographical information servers 106, 108 where the spatial data is stored in a digital format in the associated database 118, 120 of the respective system. The databases 118, 120 associated with the first and second geographic information systems 102, 104 respectively may include any data storage structures known in the art. The spatial data can be directly entered into the geographical information servers 106, 108 from digital data collection systems provided in association with the multiple machines operating on the worksite. Positions from a Global Positioning System (GPS), satellites and remotely sensed data from sensors, such as, for example, cameras, digital scanners, and light detection and ranging (LIDAR) devices, can also be directly entered into the geographical information servers 106, 108. Any object or zone that can be located spatially can be input and stored into the geographical information servers 106, 108. The geographical information servers 106, 108 may also posses the capability of converting existing digital information, which cannot yet be in map form, into forms that can be recognized and mapped into a visually representable format. The spatial data, after it has been converted, organized, and projected onto the appropriate map by the above methods, can be displayed on the human machine interface devices 110, 112, 114, 116 associated with the respective systems.

The human machine interface devices 110, 112, 114, 116 may include any controller, display device, handheld or portable device having capabilities of accessing the spatial data stored within the respective geographical information server 106, 108 of the first or second geographic information system 102, 104. The human machine interface devices 110, 112, 114, 116 also provides a means of accepting inputs from a user of the system for interaction with the respective first or second geographic information system. For example, the human machine interface devices 110, 112, 114, 116 may include a monitor for displaying a web page so that the user can visualize the spatial data in a form of a map based on results of analyses or simulations performed by the respective first or second geographic information system 102, 104.

The first and second geographic information systems 102, 104 are communicably coupled to each other via a network 122. The network 122 may be, but not limited to, a wide area network (WAN), a local area network (LAN), an Ethernet, an Internet, an Intranet, a cellular network, a satellite network, or any other suitable network for transmitting the spatial data between the first and second geographic information systems 102, 104. In various embodiments, the network 122 may include a combination of two or more of the aforementioned networks and/or other types of networks known in the art. The network 122 may be implemented as a wired network, a wireless network or a combination thereof. Further, data transmission make take place over the network 122 with a network protocol such that the data transmission is in an encrypted format, any other secure format, or in any of a wide variety of known manners.

A person of ordinary skill in the art will appreciate that the first and second geographic information systems 102, 104 described above are exemplary and do not limit the scope of the present disclosure. The first and second geographic information systems 102, 104 may additionally include other components not described herein. Moreover, additional number of geographical information servers, databases, input or output devices may be included in the system. The system architecture described above is exemplary and may vary based on the requirements.

The present disclosure relates to sharing of the spatial data associated with one of the first and second geographic information systems 102, 104 with the other. For the purpose of explanation, the sharing will be explained with reference to the transfer of the spatial data from the first geographic information system 102 to the second geographic information system 104.

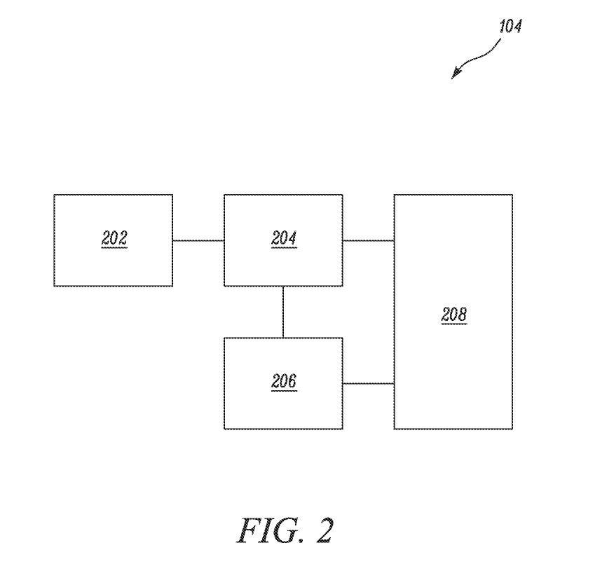

Referring to FIG. 2, a block diagram of the second geographic information system 104 is illustrated. The second geographic information system 104 includes a receiving module 202, a user interface module 204, a selection module 206, and a display module 208. The receiving module 202 is configured to perform initial communication with the first geographic information system 102. Further, the receiving module 202 may receive a description of the first set of layers of spatial data that are available on the first geographic information system 102. The description of the first set of layers of spatial data is such that the description may be indicative of the type and content of the spatial data present in the first set of layers. For example, the description may include metadata associated with the first set of layers. A person of ordinary skill in the art will appreciate that the description of the first set of layers of spatial data may include information required to identify the spatial data present on the first geographic information system 102, for initiating the data communication with the second geographic information system 104.

The user interface module 204 is communicably coupled to the receiving module 202. The user interface module 204 is configured to define a user interface on the second geographic information system 104. The user interface 204 may include capabilities of accessing or extracting from the second geographic information system 104 the second set of layers of spatial data that are available on the second geographic information system 104, along with the first set of layers of spatial data which may be shared from the first geographic information system 102 based on the description. For example, the user interface may include a list of names of the first set layers which may be shared from the first geographic information system 102 to the second geographic information system 104 and a list of names of the second set of layers of spatial data which are local to the second geographic information system 104.

A person of ordinary skill in the art will appreciate that the description of the first set of layers of the spatial data may include some of the layers of spatial data that are available on the first geographic information system 102 for sharing with the second geographic information system 104, while those layer of the spatial data that cannot be shared may be hidden. Such rules governing restriction of communicating the description of the layers which cannot be shared may be pre-defined based on the application and system requirements. A display of the user interface may be viewable on an output device associated with the second geographic information system 104.

Further, the selection module 206 is communicably coupled to the user interface module 204. The selection module 206 is configured to allow the user to select layers through the user interface defined by the user interface module 204. Accordingly, the user is allowed to select layers from the first and second set of layers of spatial data defined via the user interface. The selection of layers through the user interface is based on a user input. The selected layers may include at least a subset of the first or second set of layers of spatial data. For example, the selected layers may include the names of the layers against which a check box provided the respective name of the given layer is checked.

The user interface module 204 and the selection module 206 are communicably coupled to the display module 208. Based on the user input, the display module 208 may receive, from the first geographic information system 102, the first set of layers of spatial data selected by the user. Further, the display module 208 may display an overlay of the selected layers, including the spatial data from the first and second geographic information systems 102, 104, on the display module 208 associated with the second geographic information system 104. The display module 208 may be embodied as any output device capable of displaying the overlay thereon. The display module 208 may include a monitor, a screen, a LCD panel, and so on. In one embodiment, the display module 208 may be capable of accepting inputs from the user and may include a touch screen.

One of ordinary skill in the art will appreciate that the modules 202, 204, 206, 208 described herein are merely on an exemplary basis. The functionalities performed by the individual modules 202, 204, 206, 208 may be performed in combination without any limitation. Further, additional functionalities may be performed by any of the modules 202, 204, 206, 208. The each of the modules 202, 204, 206, 208 may be implemented on components of the second geographic information system 104 based on the system design and architecture.

The overlay displayed by the display module 208 may include a graphical representation of the selected layers of spatial data. Optionally, the user may be allowed to input an ordering for the selected layers, such that based on the ordering provided by the user, the ordering of the selected layers displayed on the user interface by the display module 208, may be changed or re-ordered. Accordingly, the display module may 208 accept the input from the user via the user interface. A person of ordinary skill in the art will appreciate that in some situations, the spatial data of the selected layers may overlap on some or all areas of the display. In such cases, by providing the user the ability to order the selected layers as per his viewing needs and requirements, the user may choose which layers of the spatial data is to be viewed in the foreground or which layers is to be viewed in the background.

The user may also be provided with an option of selecting a background image over which the overlay is displayed. The background image may include a map of the worksite, a satellite image or a solid color of the user's choice. Further, the user may also change a representation of at least one parameter of the first set of layers, the second set of layers, or the selected layers based on a user command provided through the user interface. The at least one parameter may include a transparency, an opacity, a color, and a name of the first set layers, the second set of layers, or the selected layers respectively. For example, a slider bar may be provided in association with each of the layers for display, such that based on the user positioning a bar on the slider, the opacity of the selected layer may increase or decrease accordingly. It should be noted that the user interface may additionally provide functionalities associated with the overlay not described herein, without deviating from the scope of the present disclosure. For example, the user may be allowed to zoom in or zoom out of the overlay, change a resolution of the display, select a particular area of the worksite for the display, and so on.

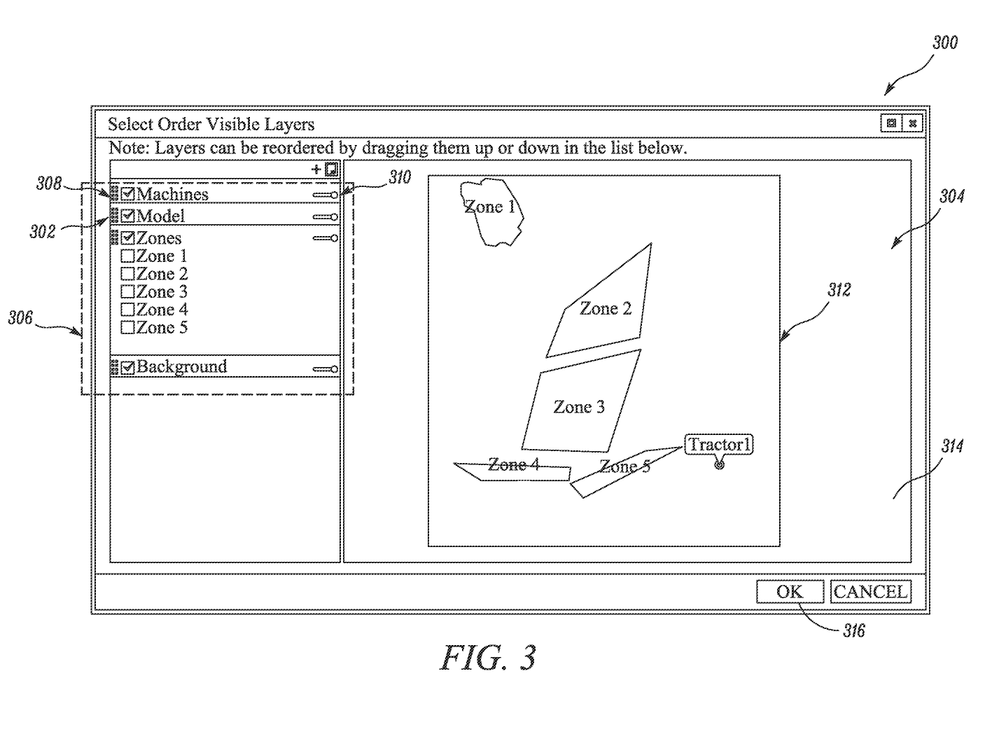

Referring to FIG. 3, an exemplary display 300 viewable on the first geographic information system 102 is illustrated. The display 300 includes a first display area 302 and a second display area 304. The first display area 302 includes a list of names of the first set of layers 306 that may be viewed on the second display area 304, based on a selection of the layer. In this example, the first set of layers 306 includes layers having the names of “Machines”, “Model”, “Zones”, and “Background”. The “Zones” layer further includes layers “Zone 1”, “Zone 2”, “Zone 3”, “Zone 4”, and “Zone 5”. Each of these “Zones” may be designated a specific color either by the user or the system. By checking the checkbox 308 provided in the first display area 302, the layer may be selected by the user. Based on user selection of the layers provided in first display area 302, the layers may be represented in a graphical form on the second display area 304. Accordingly, based on the selected layers from the first set of layers 306, the “Zone 1”, “Zone 2”, “Zone 3”, “Zone 4”, “Zone 5” and “Tractor1” are displayed on the second display area 304 in a graphical form.

Further, based on a position of the slider 310 placed near the first set of layers 306 a transparency of the said layer may be changed by the user. The boundary 312 provided in the second display area 304 is indicative of a boundary of the worksite. A background image 314 in the second display area 304 may be of any color. Alternatively, the background image 314 may include the satellite image of the worksite. A person of ordinary skill in the art will appreciate that the number of display 300 shown in the accompanying figures is exemplary and does not limit the scope of the present disclosure. Further, the first display area 302 may be hidden after the user has selected an “OK” option 316, so that the display 300 may include the second display area 304 and the first display area 302 may be hidden or collapsed. Additionally, it should be noted that the first set of layers 306 may change dynamically based on real time changes in the spatial data stored and managed by the first geographic information system 102.

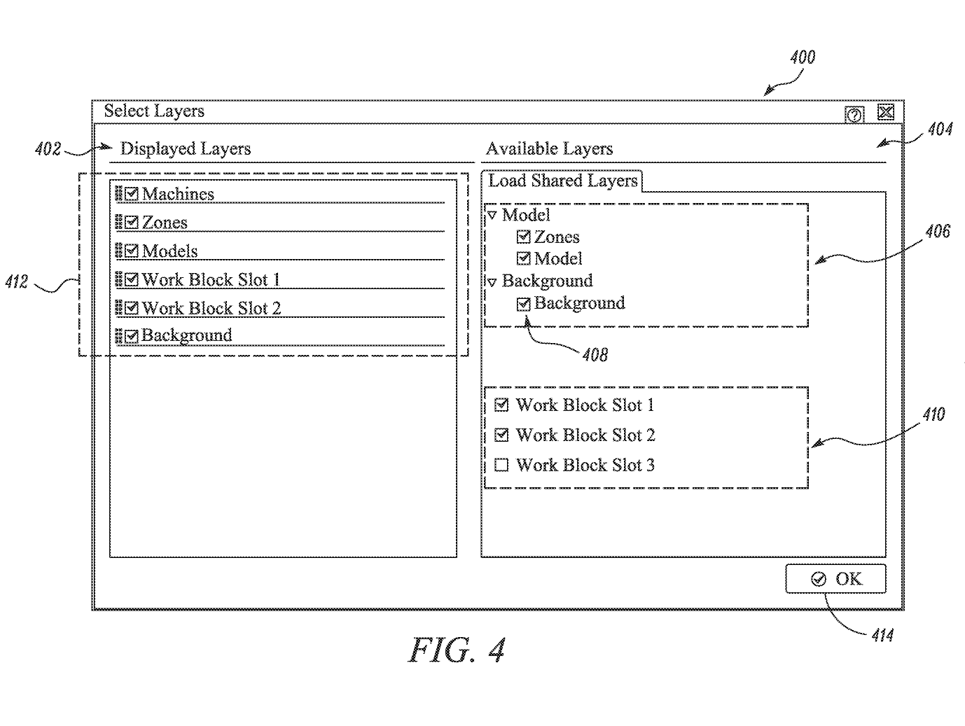

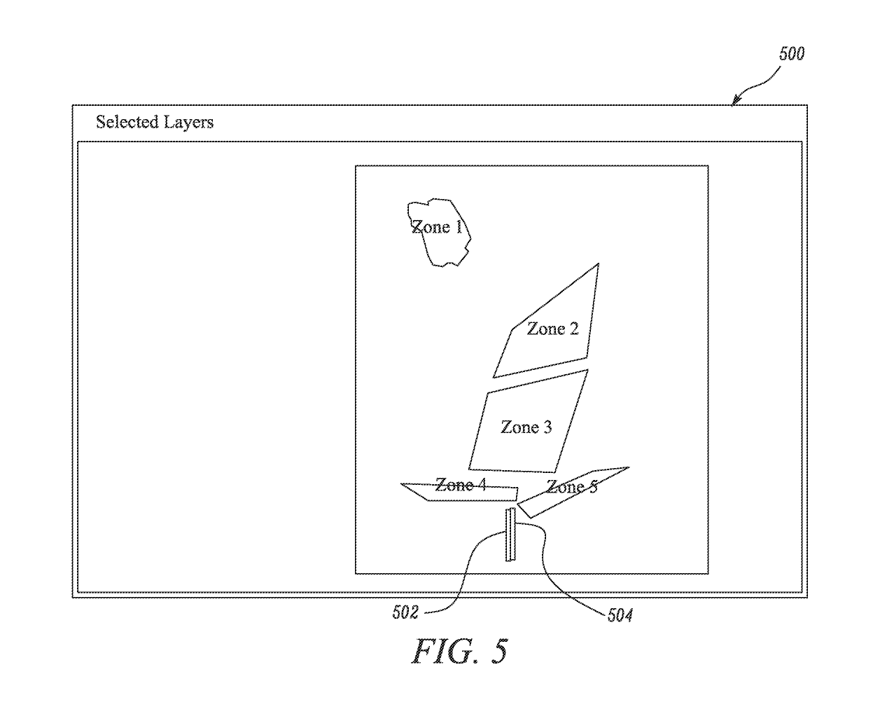

Once the initial communication between the first and second geographic information systems 102, 104 is established, the user interface may be displayed on the display module 208 of the second geographic information system 104. FIG. 4 illustrates an exemplary display 400 viewable on the second geographic information system 104. In this example, the display 400 includes a first section 402 of “Displayed Layers” and a second section 404 of “Available Layers”. The “Available Layers” includes the description of the first set of layers 306 that may be shared from the first geographic information system 102 to the second geographic information system 104, based on the user request.

A subset 406 of first set of the layers 406 that may be shared from the first geographic information system 102 can be viewed by the user in the “Load Shared Layers” tab including the “Zones” and “Model”. Further, the “Background” may also be included in the subset of the first set of layer 406 and may be made available from the first geographic system 102 based on the user selection. The user may select the layers to be displayed by checking the respective checkbox 408. Based on the selection of the layers, the layers may be displayed in the “Displayed Layers” of the first section 402 section of the display 400. The second section 404 of the display 400 may include the subset of the first set of layers 406 which may be shared from the first geographic information system 102 based on the user selection, and also includes the second set of layers 410 which are available on the second geographic information system 104. i.e., “Work Block Slot 1”, “Work Block Slot 2”, and “Work Block Slot 3”.

Further, in the “Displayed Layers” of the first section 402, the user may drag and drop the selected layers 412 for changing the ordering of the selected layers 412 on the overlay. Accordingly, the ordering of the overlay of the selected layers 412 is such that the “Machines” are over the “Zones”, the “Zones” are over the “Model”, the “Model” is over the “Work Block Slot 1” and the “Work Block Slot 2”, and the “Work Block Slot 1” and the “Work Block Slot 2” is over the “Background” of the selected layers 412 in the overlay. The user may not be provided with the option of viewing some of the first set of layers 306, for example, the “Machine” layer (see FIG. 3), and hence, the “Machine” layer may not appear in the list of the “Available Layers” in the second section 404 for sharing.

Further, after the user has clicked the “OK” option 414, the first set of layers 406 selected by the user may be received, from the first geographic information system 102. A person of ordinary skill in the art will appreciate that the first set of layers 406 that may be shared from the first geographic information system 102 may change on a real-time basis.

FIG. 5 is an exemplary display 500 viewable on the second geographic information system 104 based on the selected layers 412 (see FIG. 4). According to the selection made by the user, the display 500 includes the subset of the first and second set of layers, such as, “Zone 1”, “Zone 2”, “Zone 3”, “Zone 4”, “Zone 5”, “Work Block Slot 1” represented as a block 502 and “Work Block Slot 2” represented as a block 504. The display 500 is the resultant output provided on the second geographic information system 104 based on selective spatial data sharing with the first geographic information system 102.

A person of ordinary skill in the art will appreciate that the displays 300, 400, 500 described herein are exemplary and do not limit the scope of the present disclosure. The user interface may additionally include other functionality not described herein. Further, the first and second set of layers of spatial data may change on a real time basis. Although the description above is with reference to the communication of the spatial data from the first geographic information system 102 to the second geographic information system 104, the data communication from the second geographic information system 104 to the first geographic information system 102 is also possible in a similar way. Further, the system may include additional geographic information systems, such that the data communication for the sharing of the spatial data between pairs of the geographic information system may take place in the manner specified above.

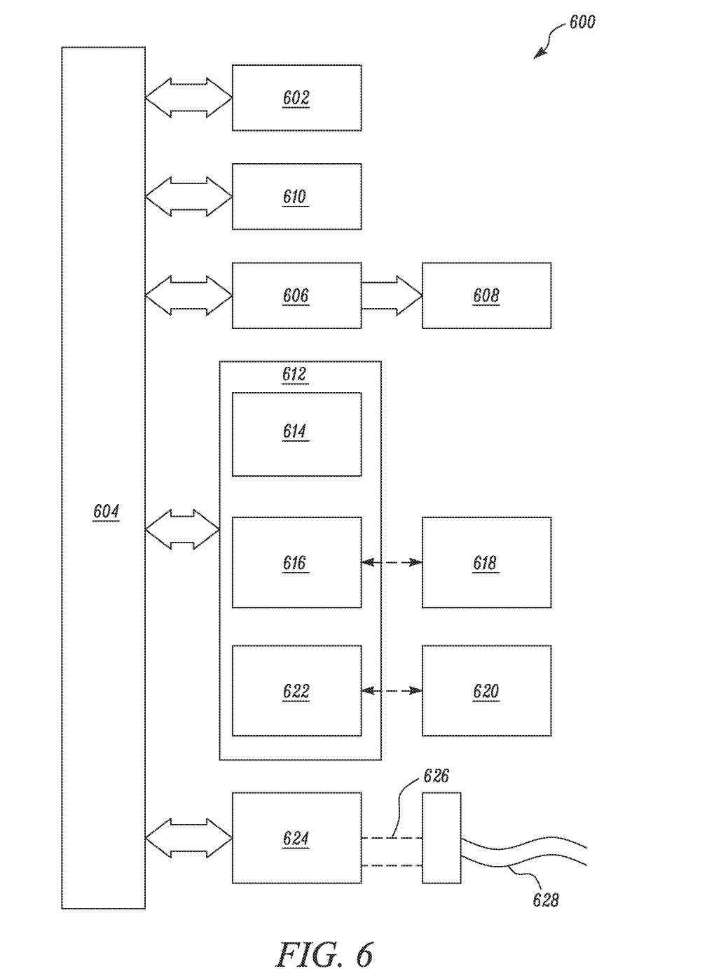

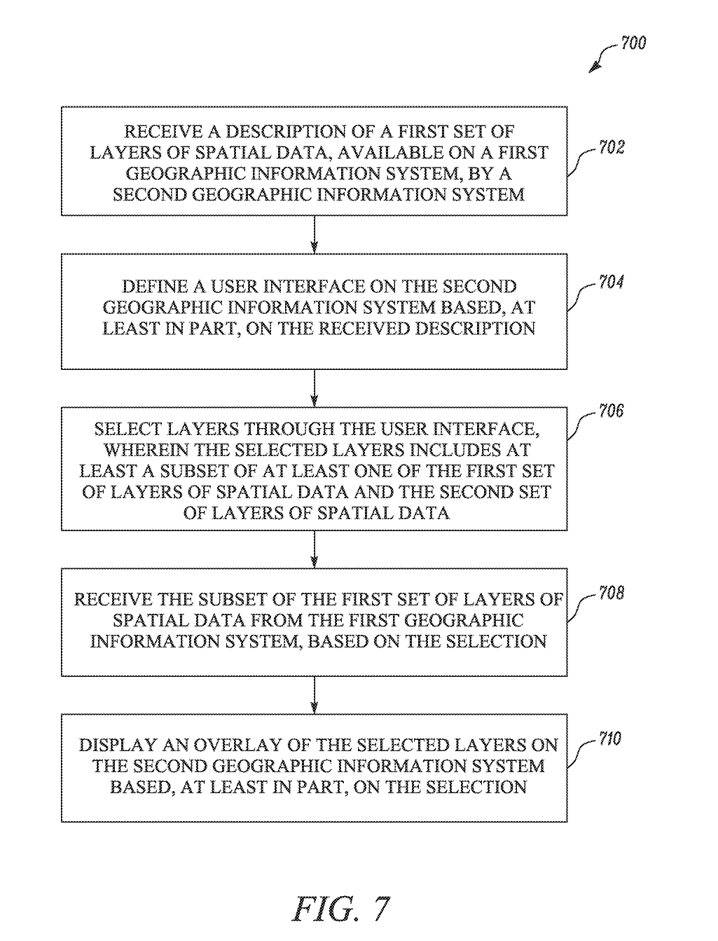

In fact, in accordance with an embodiment of the present disclosure, the present disclosure is directed towards one or more computer systems capable of carrying out the functionality described herein. An example of the computer based system includes a computer based system 600, which is shown by way of a block diagram in FIG. 6.

The computer based system 600 includes at least one processor, such as a processor 602. The processor 602 may be connected to a communication infrastructure 604, for example, a communications bus, a cross-over bar, a network, and the like. Various software embodiments are described in terms of this exemplary computer based system 600. Upon perusal of the present description, it will become apparent to a person skilled in the relevant art(s) how to implement the present disclosure using other computer systems and/or architectures.

The computer based system 600 includes a display interface 606 that forwards graphics, text, and other data from the communication infrastructure 604, or from a frame buffer (not shown) for display on a display unit 608.

The computer based system 600 further includes a main memory 610, such as random access memory (RAM), and may also include a secondary memory 612. The secondary memory 412 may further include, for example, a hard disk drive 614 or a removable storage drive 616, representing a floppy disk drive, a magnetic tape drive, an optical disk drive, etc. The removable storage drive 616 reads from and/or writes to a removable storage unit 618 in a well known manner. The removable storage unit 618 may represent a floppy disk, magnetic tape or an optical disk, and may be read by and written to by the removable storage drive 616. As will be appreciated, the removable storage unit 618 includes a computer usable storage medium having stored therein, computer software and/or data.

In accordance with various embodiments of the present disclosure, the secondary memory 612 may include other similar devices for allowing computer programs or other instructions to be loaded into the computer based system 600. Such devices may include, for example, a removable storage unit 620, and an interface 622. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit 620 to the computer based system 600.

The computer based system 600 may further include a communication interface 624. The communication interface 624 allows software and data to be transferred between the computer based system 600 and external devices. Examples of the communication interface 624 include, but may not be limited to a modem, a network interface (such as an Ethernet card), a communications port, a Personal Computer Memory Card International Association (PCMCIA) slot and card, and the like. Software and data transferred via the communication interface 624 may be in the form of a plurality of signals, hereinafter referred to as signals 626, which may be electronic, electromagnetic, optical or other signals capable of being received by the communication interface 624. The signals 626 may be provided to the communication interface 624 via a communication path (e.g., channel) 628. The communication path 628 carries the signals 626 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 616, a hard disk installed in the hard disk drive 614, the signals 626, and the like. These computer program products provide software to the computer based system 600. The present disclosure is directed to such computer program products.

Computer programs (also referred to as computer control logic) may be stored in the main memory 610 and/or the secondary memory 612. The computer programs may also be received via the communication interface 604. Such computer programs, when executed, enable the computer based system 600 to perform the functions consistent with the present disclosure, as discussed herein. In particular, the computer programs, when executed, enable the processor 602 to perform the features of the present disclosure. Accordingly, such computer programs represent controllers of the computer based system 600.

In accordance with an embodiment of the present disclosure, where the disclosure is implemented using a software, the software may be stored in a computer program product and loaded into the computer based system 600 using the removable storage drive 616, the hard disk drive 614 or the communication interface 624. The control logic (software), when executed by the processor 602, causes the processor 602 to perform the functions of the present disclosure as described herein.

In another embodiment, the present disclosure is implemented primarily in hardware using, for example, hardware components, such as, application specific integrated circuits (ASIC). Implementation of the hardware state machine so as to perform the functions described herein will be apparent to persons skilled in the relevant art(s). In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first” and “second” or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to sharing of spatial data between the first and second geographic information systems 102, 104. One of ordinary skill in the art will appreciate that the first and second geographic information systems 102, 104 are distinct from each other and may specialize in management of different aspects or layers of the spatial data. For example, some aspects of the spatial data include elevation, materials, road networks, way points, grade blocks, and so on. Accordingly, the first and second geographic information systems 102, 104 may capture and distribute different aspects of the spatial data, i.e. the first set and the second set of layers respectively, related to a given geographic area.

The present disclosure relates to the system that may identify some layers of the spatial data that are available on one of the geographic information systems, and visualizing the spatial data which may be shared by one of the geographic information systems on the other geographic information based on user initiation. Accordingly, the system allows for an implementation in which the system may easily describe the spatial data locally available to that system, and additionally provide access for making the visualization of the spatial data local to that system available on another system, such that this shared spatial data may be displayed in the context or environment of the other system.

At step 702, the description of the first set of the layers of spatial data received from the first geographic information system 102 to the second geographic information system 104. Further, at step 704, the user interface may be defined on the second geographic information system 104 based on the received description. At step 706, the user may select through the user interface, at least a subset of the first or second set of layers of spatial data. Based on the user input, at step 708, the subset of the first set of layers of the spatial data may be received from the first geographic information system 102. At step 710, the overlay of the selected layers is displayed on the second geographic information system 104.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for sharing spatial data between a first geographic information system and a second geographic information system, the method comprising:
receiving a description of a first set of layers of spatial data, available on the first geographic information system, by the second geographic information system;
defining a user interface on the second geographic information system, the user interface configured to include a second set of layers of spatial data available on the second geographic information system and the first set of layers of spatial data based, at least in part, on the received description;
selecting layers through the user interface based on a user input, wherein the selected layers includes at least a subset of at least one of the first set of layers of spatial data or the second set of layers of spatial data;
receiving the subset of the first set of layers of spatial data from the first geographic information system, based on the selection; and
displaying an overlay of the selected layers on the second geographic information system based, at least in part, on the selection.

2. The method of claim 1 further comprising:
accepting an ordering of the selected layers through the user interface.

3. The method of claim 2 further comprising:
changing the display of the overlay of the selected layers based, at least in part, on the accepted ordering.

4. The method of claim 1 further comprising:
allowing a user selection of a background image, such that the overlay is displayed on the background image.

5. The method of claim 4, wherein the background image is at least one of a map or a satellite image.

6. The method of claim 1 further comprising:
changing a representation of at least one parameter associated with at least one of the first set of layers or the second set of layers based on a user command.

7. The method of claim 6, wherein the at least one parameter includes a transparency, an opacity, a color, or a name of the at least one of the first set of layers or the second set of layers respectively.

8. The method of claim 1, wherein at least one of the first or second sets of layers of the spatial data include at least one of a zone, a type of the machine, an attribute of the machine, an elevation of the worksite, or a position of the machine.

9. A computer based system comprising:
a first geographic information system including a plurality of geographical information servers and human machine interface devices respectively, the first geographic information system configured to store a first set of layers of spatial data associated with a number of machines operating on a worksite; and
a second geographic information system including a plurality of other geographical information servers and human machine interface devices respectively, the second geographic information system configured to store a second set of layers of the spatial data associated with the number of machines operating on the worksite;
wherein the second set of layers is different from the first set of layers, wherein the second geographic information system further includes:
a receiving module configured to receive a description of the first set of layers of spatial data from the first geographic information system;
a user interface module configured to define a user interface including the second set of layers of spatial data and the first set of layers based, at least in part, on the received description;
a selection module configured to select layers through the user interface based on a user input, wherein the selected layers includes at least a subset of at least one of the first set of layers of spatial data or the second set of layers of spatial data; and
a display module configured to:
receive the subset of the first set of layers of spatial data from the first geographic information system, based on the selection; and
display an overlay of the selected layers on the second geographic information system based, at least in part, on the selection.

10. The computer based system of claim 9, wherein the display module is further configured to accept an ordering of the selected layers through the user interface.

11. The computer based system of claim 10, wherein the display module is further configured to change the display of the overlay of the selected layers based, at least in part, on the accepted ordering.

12. The computer based system of claim 9, wherein the display module is further configured to allow a user selection of a background image, such that the overlay is displayed on the background image.

13. The computer based system of claim 12, wherein the background image is at least one of a map or a satellite image.

14. The computer based system of claim 9, wherein the display module is further configured to change a representation of at least one parameter associated with at least one of the first set of layers or the second set of layers based on a user command.

15. The computer based system of claim 14, wherein the at least one parameter includes a transparency, an opacity, a color, or a name of the at least one of the first set of layers or the second set of layers respectively.

16. The computer based system of claim 9, wherein at least one of the first or second sets of layers of the spatial data include at least one of a zone, a type of the machine, an attribute of the machine, an elevation of the worksite, or a position of the machine.

17. A non-transitory computer-readable medium having stored thereon sequences of instruction, the sequences of instruction including instruction which when executed by a computer based system for sharing spatial data between a first geographic information system and a second geographic information system, causes the second geographic information system to perform operations, comprising:
receiving a description of a first set of layers of spatial data, available on the first geographic information system, by the second geographic information system;
defining a user interface on the second geographic information system, the user interface configured to include a second set of layers of spatial data available on the second geographic information system and the first set of layers of spatial data based, at least in part, on the received description;
selecting layers through the user interface based on a user input, wherein the selected layers includes at least a subset of at least one of the first set of layers of spatial data or the second set of layers of spatial data;
receiving the subset of the first set of layers of spatial data from the first geographic information system, based on the selection; and
displaying an overlay of the selected layers on the second geographic information system based, at least in part, on the selection.

18. The non-transitory computer-readable medium of claim 17 further comprising instruction which causes the second geographic information system to perform operations, comprising accepting an ordering of the selected layers through the user interface.

19. The non-transitory computer-readable medium of claim 18 further comprising instruction which causes the second geographic information system to perform operations, comprising changing the display of the overlay of the selected layers based, at least in part, on the accepted ordering.

20. The non-transitory computer-readable medium of claim 17, wherein at least one of the first or second sets of layers of the spatial data include at least one of a zone, a type of the machine, an attribute of the machine, an elevation of the worksite, or a position of the machine.
